(19) United States
(12) Patent Application Publication
(10) Pub. No.: US 2002/0000941 A1
(43) Pub. Date: Jan. 3, 2002

(54) Antenna arrangement

(76) Inventor: Alan Johnson, Frimley (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/893,877

(22) Filed: Jun. 29, 2001

(30) Foreign Application Priority Data
Jun. 30, 2000 (GB) 0016253.7

(51) Int. Cl. H01Q 1/24

(52) U.S. Cl. 343/702; 343/700 MS

(57) ABSTRACT

The present invention relates to portable radiotelephones, and particularly to antennas for use therein.

The use of portable radiotelephones, or mobile telephones, has increased rapidly over recent years. Advancements in technology have seen the size of such devices shrink rapidly. As in other areas, the desire for smaller and smaller devices continues. However, as radiotelephones become smaller, antennas are unable to be reduced accordingly in size, since their size is directly proportional to the frequency at which they are designed to operate. Common solutions to this problem, including the use of whip/helix combinations, are deemed unacceptable for miniaturised portable or wearable radiotelephones where it is undesirable to have a permanently protruding antenna.

The present invention provides an antenna arrangement suitable for use in miniaturised radiotelephones which does not result in a permanently protruding antenna.

### BACKGROUND OF THE INVENTION

The present invention relates to portable radiotelephones, and particularly to antennas for use in such devices.

The use of portable radiotelephones, or mobile telephones, has increased rapidly over recent years. Advancements in technology have seen the size of such devices shrink from the size of a large briefcase, to sizes that easily fit into a shirt pocket. As in other areas of technology, the desire for smaller and smaller devices continues.

All radiotelephones require an antenna to radiate and to receive electromagnetic radiation. The size of an antenna is governed by the frequency at which it is designed to operate. A common type of antenna used in portable radiotelephones is the monopole antenna. This generally takes the form of an extensible whip.

The length of a typical monopole antenna is usually designed to be one quarter of the wavelength of the signals it is intended to transmit or receive. At a frequency of 900 Mhz (one of the frequencies typically used by portable radiotelephones), the wavelength, λ, is around 34 cm. (λ=c/f, where c is the speed of light, and f is the frequency). Therefore a typical monopole antenna for a portable radiotelephone intended for use around 900 Mhz, will be around 8.5 cm in length.

It can be seen, therefore, that although the miniaturisation of electronic components continues, there is a physical constraint on the minimum size of antenna that can be used. In such cases, the antenna can represent a large percentage of the size of a portable radiotelephone. This is particularly problematic as is becomes increasingly desirable for portable radiotelephones to become ever smaller in size. Such miniaturised devices are suitable for incorporated into wristwatches, clothing and the like.

To avoid the problem of having a permanently extended monopole antenna, many portable radiotelephones use a whip/helix antenna combination. A whip/helix combination comprises two antenna elements (a whip antenna, and a helix antenna) which operate either individually or in combination. Both a whip and helix are types of monopole antenna. In standby operation, the whip antenna is retracted within the case of the portable radiotelephone and is effectively de-coupled from the helix antenna. The helix antenna gives adequate performance for detecting when a call is being made to the radiotelephone. When a call is answered, the whip antenna is manually extended to provide a monopole antenna. The mechanics of such whip/helix combinations generally disconnect or decouple the helix stub whilst extended, effectively providing a standard monopole antenna. When the whip antenna is retracted, the helix stub is connected and the whip antenna is disconnected. The whip antenna provides extra performance which is beneficial whilst making and receiving calls. For reasons of performance, however, even when the whip antenna is retracted, the helix stub must protrude from the case of the portable radiotelephone.

Another type of commonly used antenna type is the Planar Inverted-F Antenna (PIFA). PIFA antennas are such that they can be designed to be entirely internal to a radiotelephone and still give adequate performance for both standby and operational use. This removes the need to have an external antenna. However, PIFA antennas do require a suitably large groundplane and antenna volume.

In current hand-held sized portable radiotelephones, such as the Nokia 8210, the required size of the groundplane is easily incorporated within the internal circuit boards. However, as the sizes of the circuit boards are reduced, the corresponding space available for the groundplanes is also reduced. For PIFA antennas, as with monopole antennas, the size of the groundplane is typically the same length as the antenna. If the groundplane is smaller than the antenna, the antenna performance will be sub-optimal.

A problem therefore exists, in the case of miniaturised portable radiotelephones, whereby current internal antennas cannot give adequate performance due to physical size constraints. In addition to this, the reduction in overall size leads to a reduction in the volume of the antenna, such that the volume of a PIFA antenna cannot provide adequate performance for operation of the telephone.

Accordingly, one aim of the present invention is to provide an antenna system suitable for use in portable radiotelephones, and especially for use in miniaturised portable radiotelephones.

### SUMMARY OF THE INVENTION

According to a first aspect of the present invention, there is provided An antenna arrangement comprising an antenna element capable of being moved between a first and a second position, such that in the first position the antenna element is connected to a first feed point and an electrical ground and substantially exhibits the properties of a first antenna type, and in the second position the antenna element is connected to a second feed point and substantially exhibits the properties of a second antenna type.

This has the advantage of enabling a miniaturised portable radiotelephone to be realised without the need for a permanently protruding antenna.

Further, a single antenna element can be used to provide an antenna with dual antenna characteristics. In a first position, the antenna element exhibits the properties of a PIFA antenna type. This enables a non-protruding antenna to be used during a standby mode. Once a call is initiated or received, the single antenna element can be transformed into a monopole antenna type to give the increased antenna performance it is desirable to have whilst making or receiving a call.

The use of a single antenna element to provide dual antenna characteristics is cost-effective, reduces the number of components required (and hence also the weight) and simplifies the design and manufacture of miniaturised portable radiotelephones. It also helps ensure adequate antenna performance both in stand-by and normal operation of the radiotelephone.

### BRIEF DESCRIPTION OF THE DRAWINGS

The invention will now be described, by way of example only, with reference to the accompanying diagrams, in which:

FIG. 1 is a block diagram showing an overview of a portable radiotelephone according to the present invention;

FIG. 2 is a schematic diagram showing a first embodiment of the present invention;

FIG. 3 is a schematic diagram showing a second embodiment of the present invention; and

FIG. 4 is a block diagram of a portable radiotelephone according to the present invention.

### DETAILED DESCRIPTION OF THE INVENTION

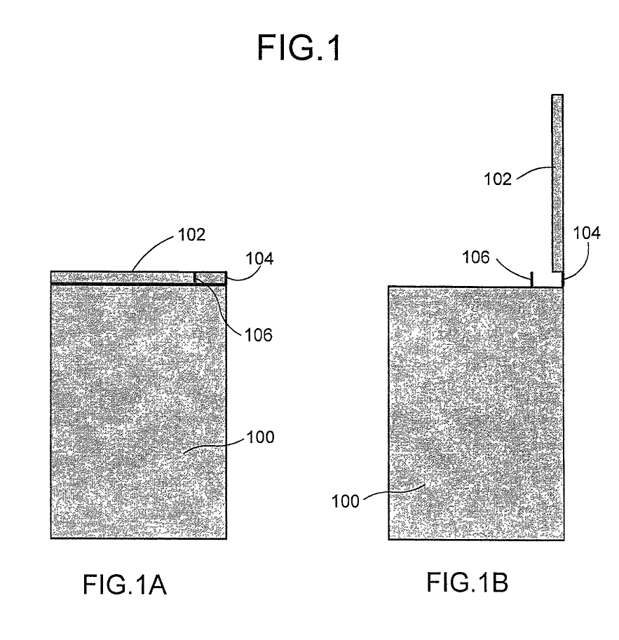

Referring now to FIG. 1, there is shown an overview of a portable radiotelephone according to the present invention.

FIG. 1a shows a portable radiotelephone 100 having an antenna element 102 in contact with a first feed point 104 and a second feed point 106. In this configuration, the antenna element 102 is substantially parallel to the top of the portable radiotelephone 100 and exhibits the properties of a planar inverted-F antenna (PIFA).

FIG. 1b shows the portable radiotelephone 100 with the antenna element 102 in an extended position. In the extended position only the first feed point 104 is in contact with the antenna element 102. In this configuration, the antenna element 102 is substantially perpendicular to the top of the portable radiotelephone 100 and exhibits the properties of a monopole antenna.

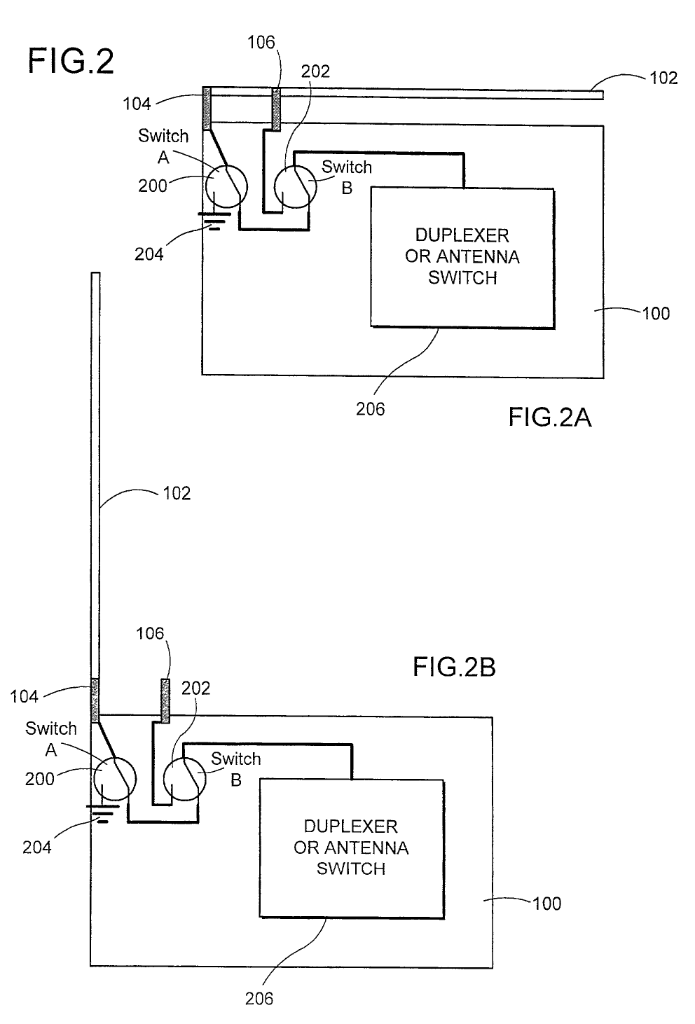

FIG. 2 shows a schematic diagram of a first embodiment of the present invention. FIGS. 2a and 2b show in detail how the internal connections are made between the feed points 104 and 106 and the internal circuitry of the portable radiotelephone 100. When the antenna element 102 is in the lowered position (as shown in FIG. 2a), the antenna element 102 is electrically connected at or near its base to the first feed point 104. At some distance from its base, depending on the design characteristics of the antenna (which will be apparent to those skilled in the art), the antenna element 102 is also in electrical contact with the second feed point 106. A switch 200 connects the first feed point 104 with an electrical ground 204. A switch 202 connects the second feed point 106 with a duplexer or antenna switch 206. In this configuration, the antenna element substantially exhibits the properties of a PIFA antenna. The duplexer 206 forms part of the conventional circuitry of a radiotelephone and will not be discussed further.

FIG. 2b shows the electrical connections made when the antenna element 102 is in the extended position. When the antenna element 102 is raised to the substantially vertical position, the contact between the second feed point 106 and the antenna element 102 is broken. Once the antenna is in the raised position, the switches 200 and 202 switch to provide the electrical connections as shown in FIG. 2b; thereby connecting the first feed point 104 to the duplexer or antenna switch 206, and leaving the second feed point 106 not connected, or floating. In one embodiment, the switching mechanism is triggered electronically using a detector circuit (not shown) which detects when the antenna element 102 is no longer in electrical contact with the second feed point 106. In a further embodiment, the switching mechanism is triggered by a mechanical switch element (not shown) which forms part of the second feed point 106. In yet a further embodiment, the switching mechanism is triggered by a mechanical switch which forms part of the first feed point 104, which detects when the antenna element is no longer in the lowered position. In the raised position the antenna element 102 substantially exhibits the properties of a monopole antenna.

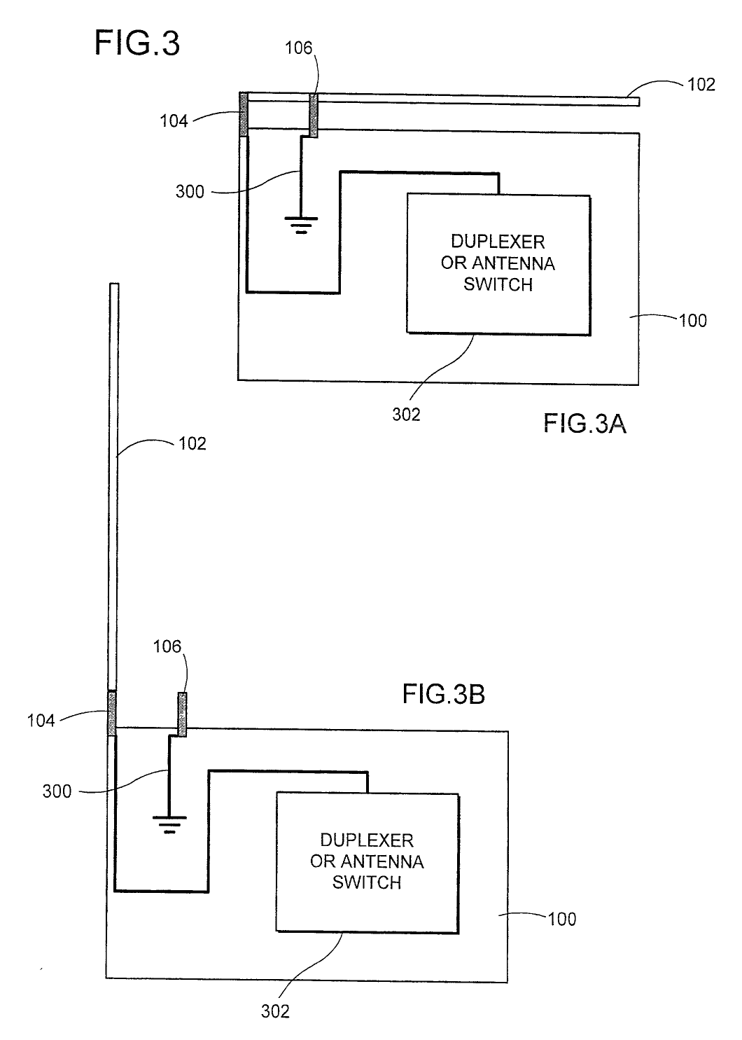

FIG. 3 shows a schematic diagram of a second embodiment of the present invention. FIGS. 3a and 3b show in detail how the internal connections are made between the feed points 104 and 106 and the internal circuitry of the portable radiotelephone 100. When the antenna element 102 is in the lowered position (FIG. 3a), the antenna element 102 is in contact with the first and second feed points 104 and 106 respectively. In this embodiment, the second feed point 106 is connected to an electrical ground 300. The first feed point 104 is connected to a duplexer or antenna switch 302. In this configuration, the antenna element 102 substantially exhibits the properties of a PIFA antenna.

When the antenna element 102 is in the raised position (FIG. 3b) the contact with the second feed point 106 is broken, and the antenna element is connected only near its base to the duplexer or antenna switch 302. In this configuration, the antenna element 102 substantially exhibits the properties of a monopole antenna. Advantageously, the second embodiment removes the requirement for switch circuitry within the portable radiotelephone as the switching is effected entirely mechanically. This reduces the complexity of the internal circuitry needed, and has weight, space and cost saving implications. The first feed point 104 may be a hinge or connected to a hinge, or the like, which allows the antenna to be raised and lowered depending on the type of antenna characteristics required. The hinge may be electrically conductive and therefore be electrically connected to the antenna element 102 and the internal circuitry of the portable radiotelephone 200. Alternatively, the hinge may be made of a non-conductive material and the electrical connection between the antenna element 102 and the internal circuitry may made be using a fixed or flexible electrical conductor. The hinge may also have one or more effective ‘locking’ positions, for example, to prevent the antenna from being accidentally disconnected from the second feed point 106 whilst in the lowered position. Such a locking position may, for example, require extra force to be applied to the antenna element 102 in order to move it between the raised and lowered positions. Alternatively, a push button release mechanism (not shown) may be used to allow the antenna element to be moved between the raised and lowered positions. In a further embodiment, the antenna element 102 may be spring loaded to automatically move the antenna element between one or both of the raised or lowered positions.

The electrical connection made between the antenna element 102 and the second feed point 106 may be by way of ‘pogo’ pin or a sprung metal pin, a spring clip, or the like. The antenna element 102 is preferably covered in an insulating material to prevent problems caused if the antenna element 102 were to come in contact with the user or other object. In this case, a suitable part of the antenna element 102 would be left uninsulated to ensure electrical contact with the second feed point 106 whilst in the lowered position.

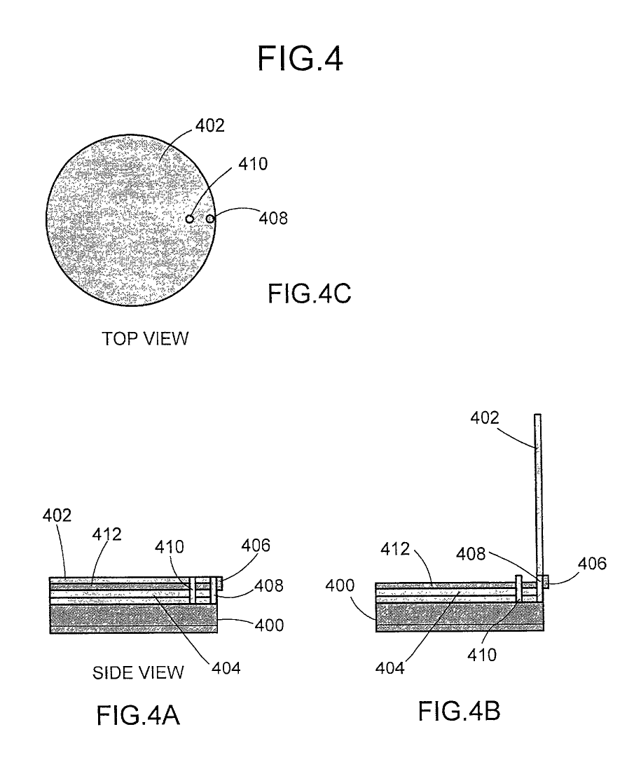

FIG. 4 shows a schematic diagram of a portable radiotelephone 400 according to the present invention. The portable radiotelephone 400 is designed as a wearable radiotelephone and is incorporated into a wristwatch or the like. The size of such a portable radiotelephone is preferably less than 25 cm³, although the exact size will depend on the functionality provided therein and the size of the display area. The portable radiotelephone 400 includes a liquid crystal display (LCD) 404 covered by a glass screen 412. An antenna element 402, of the type described above, is designed to be substantially the same shape as the portable radiotelephone 400. When the antenna element 402 is in the lowered position it is in contact with first and second feed points, 408 and 410. In this configuration the antenna substantially exhibits the properties of a PIFA antenna, as described above. In this position, the antenna element 402 also acts as a protective cover for the portable radiotelephone 400 or, alternatively, the antenna element may itself be incorporated into a protective cover. When the antenna element 402 is moved to the raised position, by way of a hinge 406, it is disconnected from the second feed point 410 and the antenna element 402 substantially exhibits the properties of a monopole antenna. In a further embodiment, the antenna could be made as part of a transparent protective cover, which advantageously would enable the liquid crystal display to be viewed even when the antenna element 402 is in the lowered position. Such an antenna could be constructed using an array of fine wires suspended in a clear material such as polycarbonate or glass. Alternatively, clear conductive materials could be used in place of the fine wires.

Those skilled in the art will appreciate that, although the present invention is described above with reference only to PIFA and monopole antennas, the inventive concepts also apply to other types of antennas. In particular, a PIFA antenna could be substituted by any other type of multi-feed point planar antenna element without detracting from the inventive concepts described herein.

What is claimed is:

1. An antenna arrangement comprising an antenna element capable of being moved between a first and a second position, such that in the first position the antenna element is connected to a first feed point and an electrical ground and substantially exhibits the properties of a first antenna type, and in the second position the antenna element is connected to a second feed point and substantially exhibits the properties of a second antenna type.

2. An antenna arrangement according to claim 1, wherein in the first position the antenna element substantially exhibits the properties of a planar inverted F-type antenna (PIFA).

3. An antenna arrangement according to claims 1 or 2, wherein in the second position the antenna element substantially exhibits the properties of a monopole antenna.

4. An antenna arrangement according to any of claims 1 to 3, wherein the first and second feed points are the same.

5. An antenna arrangement according to any preceding claim, further comprising a hinge element for effecting the movement of the antenna element between the first and second positions.

6. An antenna arrangement according to claim 5, wherein the hinge element is conductive and acts to connect one of the feed points to the antenna element.

7. An antenna arrangement according to claims 5 or 6, wherein the hinge element further comprises locking means to prevent accidental movement between the first and second positions.

8. An antenna arrangement according to any preceding claim, wherein the feed points comprise spring mounted connectors for connecting to the antenna element.

9. A portable radiotelephone having an antenna arrangement according to any of claims 1 to 8.

10. A portable radiotelephone according to claim 9, wherein in the first position the antenna element is substantially parallel to the top of the portable radiotelephone.

11. A portable radiotelephone according to claims 9 or 10, wherein in the second position the antenna element is substantially perpendicular to the top of the portable radiotelephone.

12. A portable radiotelephone according to claims 9, 10, or 11, wherein the antenna element is adapted such that, in the first position, it acts as a protective cover for substantially one face of the portable radiotelephone.

13. A portable radiotelephone according to any one of claims 9 to 12, having a volume of less than 25 cm³.

14. An antenna arrangement substantially as hereinbefore described with reference to the accompanying drawings.

15. A portable radiotelephone substantially as hereinbefore described with reference to the accompanying drawings.
